(19) United States
(12) Patent Application Publication
(10) Pub. No.: US 2015/0248178 A1
(43) Pub. Date: Sep. 3, 2015

(54) TOUCHSCREEN APPARATUS AND TOUCH SENSING METHOD

(71) Applicant: SAMSUNG ELECTRO-MECHANICS CO., LTD., Suwon (KR)

(72) Inventors: Yoon Seok Oh, Suwon (KR); Sang Hyun Sim, Suwon (KR); Hyun Suk Lee, Suwon (KR); Ji Hoon Kim, Suwon (KR)

(21) Appl. No.: 14/295,562

(22) Filed: Jun. 4, 2014

(30) Foreign Application Priority Data
Mar. 3, 2014 (KR) 10-2014-0024934

(51) Int. Cl. G06F 3/044

(52) U.S. Cl. CPC G06F 3/044

(57) ABSTRACT

A touchscreen apparatus may include: a panel unit including a plurality of driving electrodes and a plurality of sensing electrodes intersecting with the plurality of driving electrodes; a sensing circuit unit detecting levels of capacitance from the plurality of sensing electrodes; and a calculating unit generating a plurality of pieces of effective data corresponding to nodes of the plurality of driving electrodes and the plurality of sensing electrodes from the levels of capacitance.

### CROSS-REFERENCE TO RELATED APPLICATION

This application claims the benefit of Korean Patent Application No. 10-2014-0024934 filed on Mar. 3, 2014, with the Korean Intellectual Property Office, the disclosure of which is incorporated herein by reference.

### BACKGROUND

The present disclosure relates to a touchscreen apparatus and a touch sensing method.

A touch screen apparatus such as a touchscreen, a touch pad, or the like, an input apparatus attached to a display apparatus to provide an intuitive user interface, has recently been widely used in various electronic apparatuses such as cellular phones, personal digital assistants (PDAs), navigation devices, and the like. Particularly, as demand for smartphones has recently increased, the use of a touchscreen allowing for a user interface to be variously implemented in a limited form factor has increased.

Touchscreens used in portable devices can be divided into resistive type touchscreens and capacitive type touchscreens, according to a method of sensing a touch made thereto. With regard thereto, capacitive type touchscreens have advantages in that they have a relatively long lifespan and various input methods and gestures may be easily used therewith, such that the use thereof has increased. Particularly, capacitive type touchscreens may easily allow for the implementation of a multi-touch interface, as compared with resistive type touchscreens, such that capacitive type touchscreens are widely used in devices such as smartphones, and the like.

Capacitive type touchscreens include a plurality of electrodes having a predetermined pattern and defining a plurality of nodes in which changes in capacitance are generated by a touch. In the plurality of nodes distributed on a two-dimensional plane, changes in self-capacitance or in mutual-capacitance are generated by touch inputs. Coordinates of touch inputs may be calculated by applying a weighted average method, or the like, to the changes in capacitance generated in the plurality of nodes.

In recent times, the touchscreen apparatuses may receive fine and precise touch inputs through a user using a stylus, or the like, in addition to a touch directly applied by a finger, or the like and may also receive touch inputs applied thereto while being spaced apart from a touch panel by a predetermined distance or more.

The following Patent Document 1, which relates to an apparatus and a method for classifying a contact-media on a touchscreen, discloses contents recognizing a touch and a touch pen according to a comparison result of a count value and a reference value of a contact pixel, but does not disclose contents classifying a general touch input, a hovering touch input, and a stylus touch input.

### RELATED ART DOCUMENT

(Patent Document 1) Korean Patent Laid-Open Publication No. 2012-0081733

### SUMMARY

An aspect of the present disclosure may provide a touchscreen apparatus and a touch sensing method, capable of determining a type of touch input according to a level of effective data having the maximum value within at least one touch input group and the number of pieces of effective data having a predetermined level or more among peripheral effective data of the effective data having the maximum value.

According to an aspect of the present disclosure, a touchscreen apparatus may include: a panel unit including a plurality of driving electrodes and a plurality of sensing electrodes intersecting with the plurality of driving electrodes; a sensing circuit unit detecting levels of capacitance from the plurality of sensing electrodes; and a calculating unit generating a plurality of pieces of effective data corresponding to nodes of the plurality of driving electrodes and the plurality of sensing electrodes from the levels of capacitance, wherein the calculating unit sets a portion of the plurality of pieces of effective data as at least one touch input group and determines a type of touch input according to a level of a piece of effective data having the maximum value within the at least one touch input group and the number of pieces of effective data having a predetermined level or more among peripheral pieces of effective data adjacent to the piece of effective data having the maximum value.

The calculating unit may generate the pieces of effective data by subtracting a predetermined offset value from sensing data generated by performing analog-digital conversion on the levels of capacitance.

The at least one touch input group may correspond to a square region surrounding pieces of effective data having a predetermined reference value or more among the plurality of pieces of effective data, at a shortest distance.

The at least one touch input group may correspond to a touch input candidate region determined by a touch separation algorithm.

The calculating unit may compare the piece of effective data having the maximum value with a predetermined first threshold.

The calculating unit may determine that the touch input group corresponding to the piece of effective data having the maximum value is generated by a general touch input, in a case in which the piece of effective data having the maximum value is greater than the first threshold.

The calculating unit may compare the piece of effective data having the maximum value with a predetermined second threshold, in a case in which the piece of effective data having the maximum value is equal to or less than the first threshold.

The calculating unit may determine that the touch input group corresponding to the piece of effective data having the maximum value is generated by noise, in a case in which the piece of effective data having the maximum value is equal to or less than the second threshold.

The calculating unit may compare the number of pieces of effective data exceeding a predetermined third threshold among the peripheral pieces of effective data adjacent to the piece of effective data having the maximum value with a set value of the number of nodes, in a case in which the piece of effective data having the maximum value is greater than the second threshold.

The calculating unit may determine that the touch input group corresponding to the piece of effective data having the maximum value is generated by a proximity touch input, in a case in which the amount of the pieces of effective data exceeding the third threshold among the peripheral pieces of effective data adjacent to the piece of effective data having the maximum value is greater than the set value of the number of nodes.

The calculating unit may determine that the touch input group corresponding to the piece of effective data having the maximum value is generated by a stylus touch input, in a case in which the amount of the pieces of effective data exceeding the third threshold among the peripheral pieces of effective data adjacent to the piece of effective data having the maximum value is equal to or less than the set value of the number of nodes.

The type of touch input may include a general touch input, a proximity touch input, and a stylus touch input.

The third threshold may be determined from an average value of the pieces of effective data by a stylus touch input and a proximity touch input.

The third threshold may be determined by multiplying the piece of effective data having the maximum value by a predetermined threshold ratio.

According to another aspect of the present disclosure, a touchscreen apparatus may include: a panel unit including a plurality of driving electrodes and a plurality of sensing electrodes intersecting with the plurality of driving electrodes; a sensing circuit unit detecting levels of capacitance from the plurality of sensing electrodes; and a calculating unit generating a plurality of pieces of effective data corresponding to nodes of the plurality of driving electrodes and the plurality of sensing electrodes from the levels of capacitance, wherein the calculating unit sets a portion of the plurality of pieces of effective data as at least one touch input group, compares a level of a piece of effective data within the at least one touch input group with a plurality of thresholds to determine a type of touch input according to a result of the comparision, and changes a level of the plurality of thresholds in a current frame so as to maintain the type of touch input in a previous frame.

According to another aspect of the present disclosure, a touch sensing method may include: generating a plurality of pieces of effective data corresponding to nodes of a plurality of driving electrodes and a plurality of sensing electrodes; setting a portion of the plurality of pieces of effective data as at least one touch input group; and determining a type of touch input by comparing a piece of effective data having the maximum value within the at least one touch input group with predetermined first and second thresholds and comparing the number of pieces of effective data having a predetermined third threshold or more among peripheral pieces of effective data adjacent to the piece of effective data having the maximum value with a predetermined set value of the number of nodes.

The first to third thresholds and the set value of the number of nodes in a current frame may be changed so as to maintain the type of touch input in a previous frame.

In the generating of the plurality of pieces of effective data, the pieces of effective data may be generated by detecting levels of capacitance from a panel unit to which the touch input is applied, performing an analog-digital conversion on the levels of capacitance to generate sensing data, and subtracting a predetermined offset value from the sensing data.

The peripheral pieces of effective data may be included in the touch input group.

In the determining of the type of touch input, in a case in which the piece of effective data having the maximum value is greater than the first threshold, it may be determined that the touch input group corresponding to the piece of effective data having the maximum value is generated by a general touch input.

In the determining of the type of touch input, in a case in which the piece of effective data having the maximum value is equal to or less than the first threshold, the piece of effective data having the maximum value may be compared with the second threshold.

In the determining of the type of touch input, in a case in which the piece of effective data having the maximum value is equal to or less than the second threshold, it may be determined that the touch input group corresponding to the piece of effective data having the maximum value is generated by noise.

In the determining of the type of touch input, in a case in which the piece of effective data having the maximum value is greater than the second threshold, the number of pieces of effective data exceeding the third threshold among peripheral pieces of effective data adjacent to the piece of effective data having the maximum value may be compared with the set value of the number of nodes.

In the determining of the type of touch input, in a case in which the number of the pieces of effective data exceeding the third threshold among peripheral pieces of effective data adjacent to the piece of effective data having the maximum value is greater than the set value of the number of nodes, it may be determined that the touch input group corresponding to the piece of effective data having the maximum value is generated by a proximity touch input.

In the determining of the type of touch input, in a case in which the number of the pieces of effective data exceeding the third threshold among peripheral pieces of effective data adjacent to the piece of effective data having the maximum value is equal to or less than the set value of the number of nodes, it may be determined that the touch input group corresponding to the piece of effective data having the maximum value is generated by a stylus touch input.

The type of touch input may include a general touch input, a proximity touch input, and a stylus touch input.

The third threshold may be determined from an average value of the pieces of effective data by a stylus touch input and a proximity touch input.

The third threshold may be determined by multiplying the piece of effective data having the maximum value by a predetermined threshold ratio.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view showing the exterior of an electronic apparatus including a touchscreen apparatus according to an exemplary embodiment of the present disclosure;

FIG. 2 is a view showing a panel unit that may be included in the touchscreen apparatus according to an exemplary embodiment of the present disclosure;

FIG. 3 is a cross-sectional view of the panel unit that may be included in the touchscreen apparatus according to an exemplary embodiment of the present disclosure;

FIG. 4 is a view showing a touchscreen apparatus according to an exemplary embodiment of the present disclosure;

FIG. 5 is a flow chart for describing a touch sensing method according to an exemplary embodiment of the present disclosure;

FIG. 6 is a view for describing the touch sensing method according to an exemplary embodiment of the present disclosure; and

FIG. 7 is a diagram showing an example of effective data.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

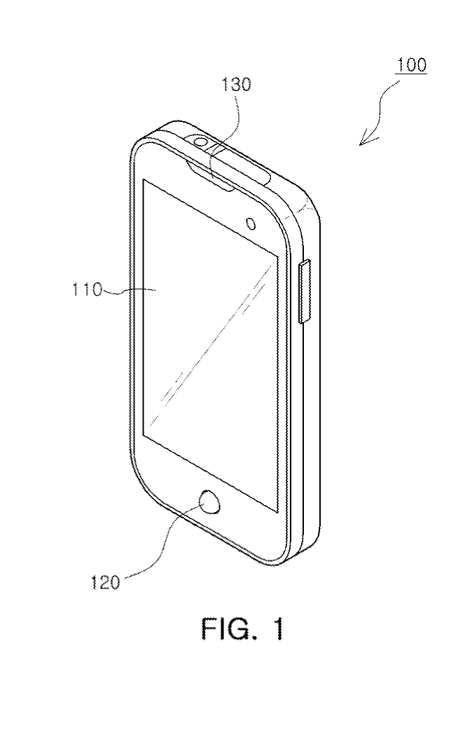

FIG. 1 is a perspective view showing the exterior of an electronic apparatus including a touchscreen apparatus according to an exemplary embodiment of the present disclosure.

Referring to FIG. 1, an electronic apparatus 100 according to the exemplary embodiment may include a display apparatus 110 for outputting a screen, an input unit 120, an audio unit 130 for outputting a sound, and the like, and may be integrated with the display apparatus 110 to provide a touchscreen apparatus.

As shown in FIG. 1, in the case of a mobile apparatus, the touchscreen apparatus is generally provided in a state in which it is integrated with the display apparatus, and needs to have high light transmissivity enough to transmit a screen displayed by the display apparatus. Therefore, the touchscreen apparatus may be implemented by forming a sensing electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephtalate (PET), polycarbonate (PC), polyethersulfone (PES), polyimide (PI), polymethyl methacrylate (PMMA), or the like. In addition, the sensing electrode may be formed of fine conductor lines formed of one of Ag, Al, Cr, Ni, Mo, and Cu, or an alloy thereof.

The display apparatus may have a wiring pattern disposed in a bezel region thereof, and the wiring pattern may be connected to the sensing electrode formed of the transparent and conductive material. Since the wiring pattern is visually shielded by the bezel region, it may also be formed of a metal material such as silver (Ag), copper (Cu), or the like.

Since the touchscreen apparatus according to an exemplary embodiment of the present disclosure may be a capacitive type touchscreen apparatus, the touchscreen apparatus may include a plurality of electrodes having a predetermined pattern. In addition, the touchscreen apparatus according to an exemplary embodiment of the present disclosure may include a capacitance detection circuit detecting changes in capacitance generated in the plurality of electrodes, an analog-to-digital conversion circuit converting an output signal from the capacitance detection circuit into a digital value, an operation circuit determining a touch input using data converted into the digital value, and the like.

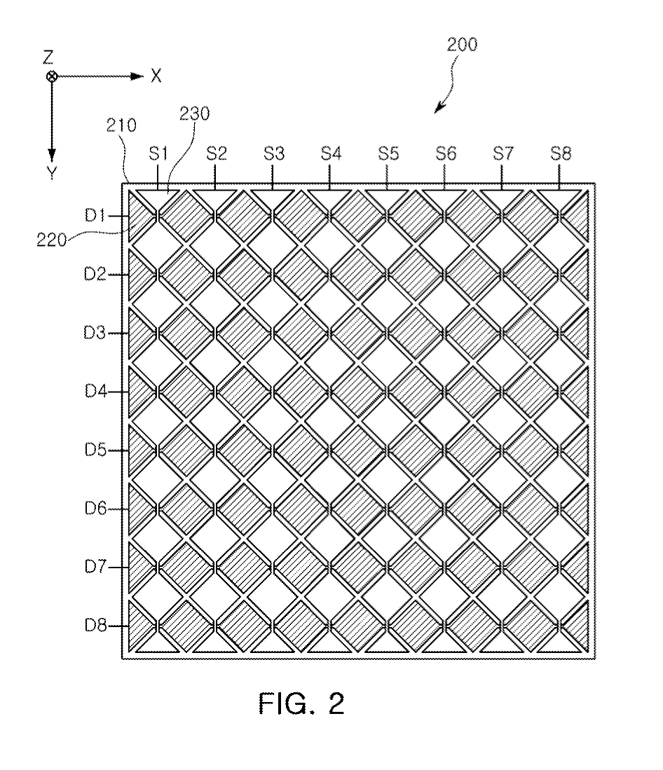

FIG. 2 is a diagram showing a panel unit that may be included in the touchscreen apparatus according to an exemplary embodiment of the present disclosure.

Referring to FIG. 2, a panel unit 200 according to the exemplary embodiment may include a substrate 210 and a plurality of electrodes 220 and 230 provided on the substrate 210. Although not shown in FIG. 2, each of the plurality of electrodes 220 and 230 may be electrically connected to a wiring pattern of a circuit board attached to one end of the substrate 210 through wirings and bonding pads. A controller integrated circuit may be mounted on a circuit board to detect sensing signals generated in the plurality of electrodes 220 and 230 and determine touch inputs from the sensing signals.

The plurality of electrodes 220 and 230 may be provided on one surface or both surfaces of the substrate 210. Although the plurality of electrodes 220 and 230 having rhombus or diamond shaped patterns are shown in FIG. 2, they may also have various polygonal patterns such as rectangular patterns, triangular patterns, or the like.

The plurality of electrodes 220 and 230 may include first electrodes 220 extended in an X-axis direction and second electrodes 230 extended in a Y-axis direction. The first electrodes 220 and the second electrodes 230 are provided on both surfaces of the substrate 210 or are provided on different substrates 210, such that they may intersect with each other. In a case in which both of the first electrodes 220 and the second electrodes 230 are provided on one surface of the substrate 210, predetermined insulating layers may be partially formed in intersections between the first electrodes 220 and the second electrodes 230.

Further, in addition to a region in which the plurality of electrodes 220 and 230 are formed, with respect to a region in which wirings connected to the plurality of electrodes 220 and 230 are provided, a predetermined printed region for visually shielding the wiring generally formed of an opaque metal material may be formed on the substrate 210.

The touchscreen apparatus electrically connected to the plurality of electrodes 220 and 230 to sense touch inputs may detect changes in capacitance generated in the plurality of electrodes 220 and 230 by the touch input and sense the touch input from the detected changes in capacitance. The first electrodes 220 may be connected to channels defined as D1 to D8 in the controller integrated circuit to thereby receive predetermined driving signals, and the second electrodes 230 may be connected to channels defined as S1 to S8 to thereby allow the touchscreen apparatus to detect a sensing signal. In this case, the controller integrated circuit may detect, as the sensing signal, changes in mutual-capacitance generated between the first electrodes 220 and the second electrodes 230.

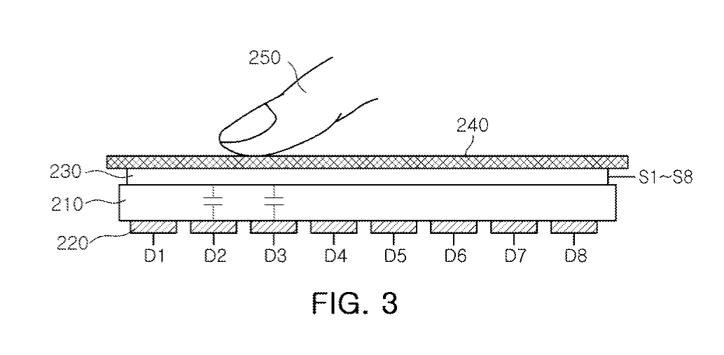

FIG. 3 is a cross-sectional view of the panel unit that may be included in the touchscreen apparatus according to an exemplary embodiment of the present disclosure. FIG. 3 is a cross-sectional view of the panel unit 200 illustrated in FIG. 2, taken along Y-Z plane. The panel unit 200 may further include a cover lens 240 receiving contact, in addition to the substrate 210 and the plurality of sensing electrodes 220 and 230 described with reference to FIG. 2. The cover lens 240 may be provided on the second electrode 230 used to detect the sensing signal and receive a touch input applied from a contact object 250 such as a finger, or the like.

When the driving signals are applied to the first electrodes 220 through the channels D1 to D8, mutual capacitance may be generated between the first electrodes 220 to which the driving signals are applied and the second electrodes 230. When the contact object 250 comes into contact with the cover lens 240, changes in mutual capacitance generated between the first electrodes 220 and the second electrodes 230 that are adjacent to a region with which the contact object 250 is brought into contact may be caused. The changes in capacitance may be proportional to an area of an overlapping region between the contact object 250 and the first electrodes 220 to which the driving signals are applied and the second electrode 230. In FIG. 3, mutual capacitance generated between the first and second electrodes 220 and 230 connected to the channels D2 and D3 may be affected by the contact object 250.

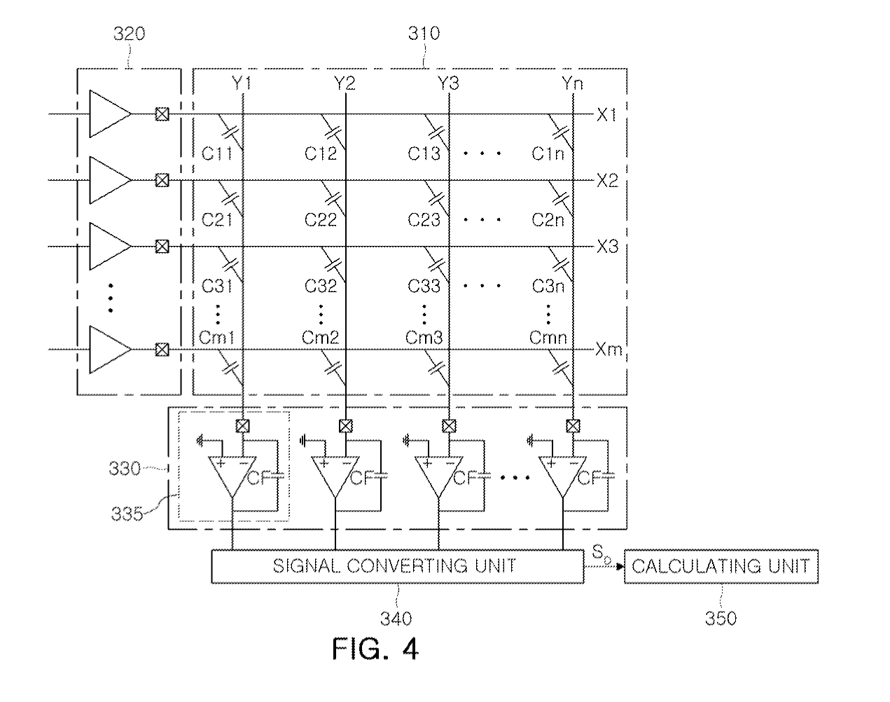

FIG. 4 is a view showing a touchscreen apparatus according to an exemplary embodiment of the present disclosure.

Referring to FIG. 4, the touchscreen apparatus according to the exemplary embodiment may include a panel unit 310, a driving circuit unit 320, a sensing circuit unit 330, a signal converting unit 340, and a calculating unit 350. In this case, the driving circuit unit 320, the sensing circuit unit 330, the signal converting unit 340, and the calculating unit 350 may be implemented in a single integrated circuit (IC).

The panel unit 310 may include a plurality of rows of first electrodes X1 to Xm extended in a first axial direction (that is, a horizontal direction of FIG. 4) and a plurality of columns of second electrodes Y1 to Yn extended in a second axial direction (that is, a vertical direction of FIG. 4) intersecting with the first axis. In this case, node capacitors C11 to Cmn may equivalently express the mutual-capacitance generated in intersections of the plurality of first electrodes X1 to Xm and the plurality of second electrodes Y1 to Yn.

The driving circuit unit 320 may apply predetermined driving signals to the plurality of first electrodes X1 to Xm of the panel unit 310. The driving signals may be square wave signals, sine wave signals, triangle wave signals, or the like, having a predetermined period and amplitude and may be sequentially applied to each of the plurality of first electrodes. Although FIG. 4 shows a case in which circuits for generating and applying the driving signals are individually connected to each of the plurality of first electrodes, a single driving signal generating circuit may also generate driving signals and apply the generated driving signals to the plurality of first electrodes, respectively, using a switching circuit. In addition, the touchscreen apparatus may be operated in a scheme in which the driving signals are simultaneously applied to all of the first electrodes or the driving signals are selectively applied to only a portion of the first electrodes to simply detect whether the touch input is present or not.

The sensing circuit unit 330 may detect levels of capacitance of the node capacitors C11 to Cmn from the plurality of second electrodes Y1 to Yn. The sensing circuit unit 330 may include a plurality of C-V converters 335 each including at least one operational amplifier and at least one capacitor, and each of the plurality of C-V converters 335 may be connected to the second electrodes Y1 to Yn.

The plurality of C-V converters 335 may convert the levels of capacitance of the node capacitors C11 to Cmn into voltage signals to thereby output analog signals. As an example, each of the plurality of C-V converters 335 may include an integrating circuit integrating the levels of capacitance. The integrating circuit may integrate the levels of capacitance and convert the integrated capacitance value into a predetermined voltage to output the predetermined voltage.

Although FIG. 4 shows a configuration of the C-V converter 335 in which a capacitor CF is disposed between an inverted terminal and an output terminal of the operational amplifier, an arrangement of the circuit configuration may also be changed. Further, although FIG. 4 shows a case in which the C-V converter 335 includes one operational amplifier and one capacitor, the C-V converter 335 may include a plurality of operational amplifiers and a plurality of capacitors.

In a case in which the driving signals are sequentially applied to the plurality of first electrodes X1 to Xm, since the levels of capacitance may be simultaneously detected from the plurality of second electrodes, the number of C-V converters 335 may correspond to the number n of second electrodes Y1 to Yn.

The signal converting unit 340 may generate digital signals S_{D} from the analog signals output from the sensing circuit unit 340. For example, the signal converting unit 340 may include a time-to-digital converter (TDC) circuit for measuring a period of time for which the analog signal output in a voltage form by the sensing circuit unit 330 reaches a predetermined reference voltage level and converting the period of time into the digital signal S_{D} or an analog-to-digital converter (ADC) circuit for measuring an amount by which a level of the analog signal output from the sensing circuit unit 330 is changed for a predetermined period of time and converting the changed amount into the digital signal S_{D}.

The calculating unit 350 may determine a touch input applied to the panel unit 310 using the digital signals S_{D}. The calculating unit 350 may determine the number of touch inputs applied to the panel unit 310, coordinates of the touch input, a gesture based on the touch input, or the like.

The digital signal S_{D}, the basis for determining the touch input by the calculating unit 350 may be data obtained by digitalizing the changes in capacitance C11 to Cmn, and particularly, may be data indicating a capacitance difference of a case in which the touch input is not generated and a case in which the touch input is generated. Typically, in the capacitive type touchscreen apparatus, a region with which a conductive object comes into contact may have reduced capacitance as compared with the case of a region in which the touch input is not generated.

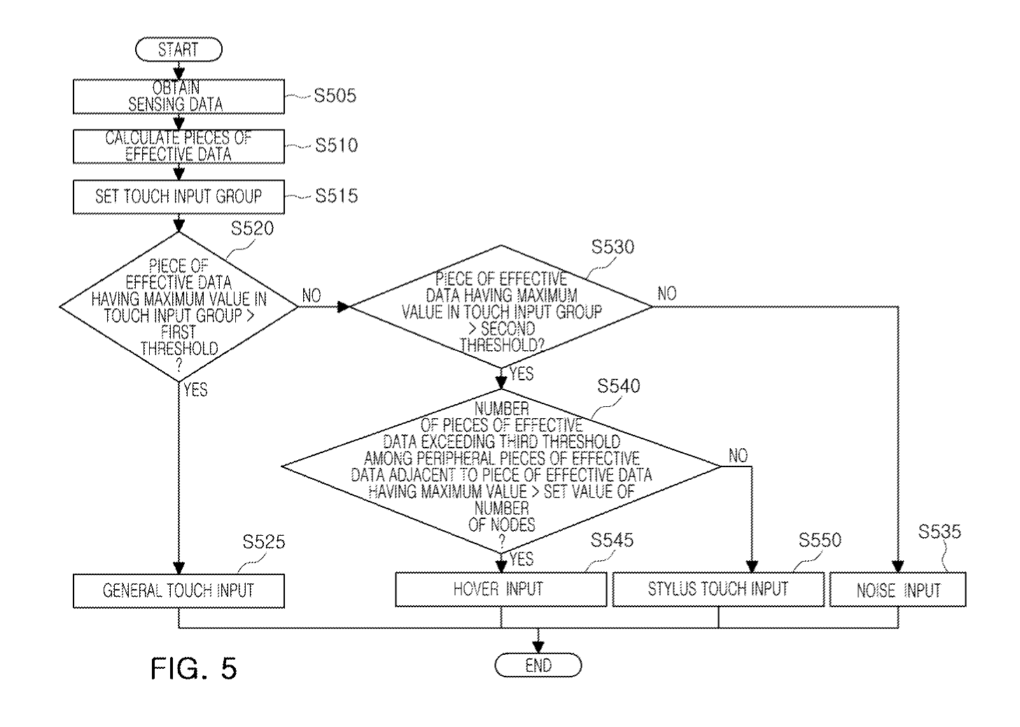

FIG. 5 is a flow chart for describing a touch sensing method according to an exemplary embodiment of the present disclosure. In order to allow a fine touch input as well as a general touch input such as a finger touch input, various stylus modules have been recently developed and in order to recognize various touch gestures, an algorithm for classifying a touch input directly applied to the touchscreen apparatus and a proximity touch input applied in a state in which it is spaced apart from the touchscreen apparatus by a predetermined distance or more has been developed. According to the exemplary embodiment, a touch input directly applied by a finger, that is, the general touch input, a touch input by the stylus, and the proximity touch input may be effectively classified.

Hereinafter, a touch sensing method according to an exemplary embodiment of the present disclosure will be described in detail with reference to FIGS. 4 through 6.

Referring to FIGS. 4 and 5, in the touch sensing method according to the exemplary embodiment, sensing data may be first obtained (S505). In order to obtain the sensing data, the driving circuit unit 320 may apply the driving signals to the plurality of first electrodes and the sensing circuit unit 330 may detect changes in capacitance from the plurality of second electrodes intersecting with the first electrodes to which the driving signals are applied. The sensing circuit unit 330 may detect the changes in capacitance in analog signal forms using the integrating circuit and the analog signals output by the sensing circuit unit 330 may be converted into the digital signals S_{D} by the signal converting unit 340. The calculating unit 350 may determine touch inputs using the digital signal S_{D} as the sensing data.

When the sensing data is obtained, the calculating unit 350 may subtract an offset value from the sensing data to calculate pieces of effective data (S510). Meanwhile, the offset value may be determined from the sensing data calculated in a case in which the touch input is not applied.

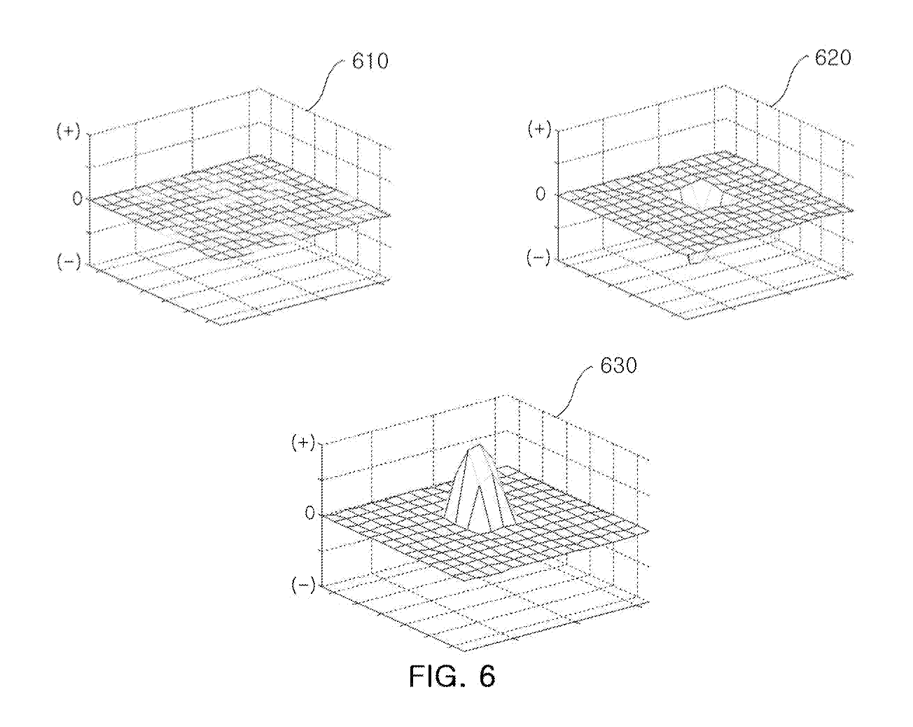

FIG. 6 is a view for describing the touch sensing method according to an exemplary embodiment of the present disclosure.

Referring to FIG. 6, a total of three graphs are shown. A first graph 610 shows sensing data obtained in a case in which the touch input by a user is not applied, and data shown in the first graph 610 may be set as an offset value.

A second graph 620 shows sensing data obtained in a case in which the touch input by the user is applied. As described above, when the conductive object such as a finger or the like contacts the panel unit 310, capacitance in the panel unit 310 is discharged to the conductive object. Consequently, sensing data may be obtained in a scheme in which a data value is reduced in a periphery region in which the conductive object contacts.

A third graph 630 shows effective data that may be calculated when the second graph 620 (the sensing data) is subtracted from the first graph 610 (the offset value). In a case in which a piece of effective data having a preset threshold or more is present among the pieces of effective data, the calculating unit 350 may determine that the touch input is applied.

The calculating unit 350 may set a portion of the pieces of effective data as at least one touch input group according to a level of the calculated effective data (S515). The touch input group may correspond to a square region surrounding effective data having a reference value or more at the shortest distance or a touch input candidate region determined by a known touch separation algorithm or the like, and one or a plurality of touch input groups may be present according to the level of the effective data.

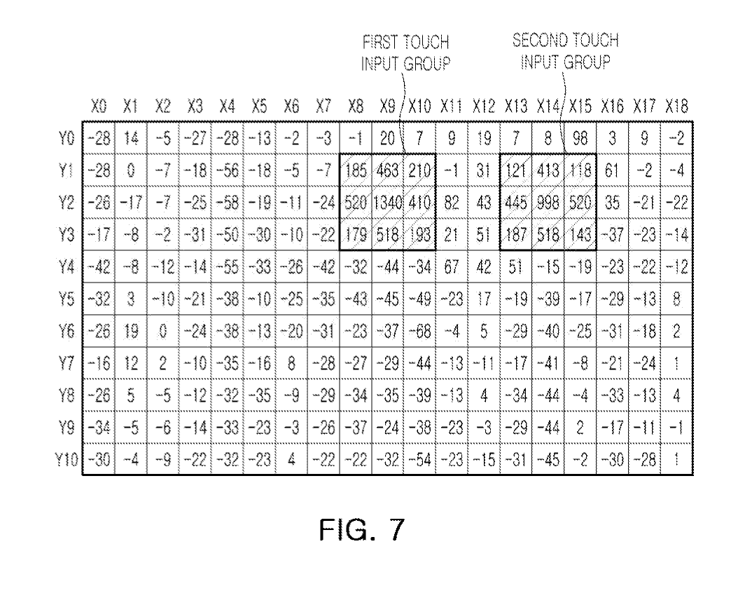

FIG. 7 is a diagram showing an example of effective data. When it is assumed that the numbers of the plurality of first electrodes X1 to Xm and the plurality of second electrodes Y1 to Yn of FIG. 4 are 18 and 10, respectively, the effective data as shown in FIG. 7 may be obtained in the respective nodes with which the plurality of first electrodes X1 to X18 and the plurality of second electrodes Y1 to Y10 are intersected.

Here, as an example, in a case in which the reference value for setting the touch input group is set to 100, first and second touch input groups may be set as shown in FIG. 7. However, the present disclosure is not limited thereto, but the touch input group may correspond to the touch input candidate region determined by the widely known touch separation algorithm.

The calculating unit 350 may compare a piece of effective data having the maximum value among a plurality of the pieces of effective data belonging to one touch input group with a first threshold (S520). The first threshold is a value for classifying a general touch input directly applied by a finger or the like and other touch inputs, and the calculating unit 350 may determine the touch input group as the general touch input in a case in which the piece of effective data having the maximum value among the plurality of pieces of effective data belonging to the touch input group is greater than the first threshold as a result of comparison (S525). For example, in a case in which the first threshold is set to 1200, since 1340 which is the piece of effective data having the maximum value within a first touch input group is greater than 1200 which is the first threshold, the calculating unit 350 may determine that effective data within the first touch input group is generated by the general touch input.

However, unlike this, in a case in which the piece of effective data having the maximum value is equal to or less than the first threshold, the calculating unit 350 may compare the piece of effective data having the maximum value with a second threshold (S530). For example, since 1113 which is the piece of effective data having the maximum value within a second touch input group is less than 1200 which is the first threshold, the calculating unit 350 may compare the piece of effective data having the maximum value within the second touch input group with the second threshold. The second threshold means a value for classifying a touch input caused by noise and the touch input due to the stylus and the proximity touch input. In a case in which the piece of effective data having the maximum value is less than the second threshold as the result of comparison, the calculating unit 350 may determine that effective data within the touch input group is generated by the noise (S535).

However, unlike this, in a case in which the piece of effective data having the maximum value among the plurality of pieces of effective data belonging to the touch input group is greater than the second threshold, the calculating unit 350 may compare the number of pieces of effective data exceeding a third threshold value among peripheral pieces of effective data of the piece of effective data having the maximum value, with a set value of the number of nodes (S540). For example, in a case in which the second threshold is set to 200, since 998 which is the piece of effective data having the maximum value within the second touch input group is greater than 200 which is the second threshold, S540 may be performed.

The peripheral pieces of effective data refer to pieces of effective data corresponding to a plurality of nodes surrounding a node corresponding to the piece of effective data having the maximum value. For example, the peripheral pieces of effective data may be determined as pieces of effective data corresponding to eight nodes surrounding a node corresponding to the piece of effective data having the maximum value within the second touch input group, in a single layer manner or determined as pieces of effective data corresponding to twenty four nodes surrounding the node corresponding to the piece of effective data having the maximum value within the second touch input group, in a double layer manner. In this case, the peripheral pieces of effective data may be present in the touch input group.

The third threshold may be predetermined from an average value of the pieces of effective data by the stylus touch input and the proximity touch input. Alternatively, the third threshold may be determined by multiplying the effective data of the node corresponding to the piece of effective data having the maximum value by a preset threshold ratio. That is, the third threshold may be varied according to the level of the piece of effective data having the maximum value.

As an example, in a case in which the third threshold is set to 400, the calculating unit 350 may compare the number of periphery nodes exceeding the third threshold of 400 with the set value of the number of nodes. In this case, since the number of nodes corresponding to pieces of effective data of 520, 518, 445, and 413 exceeding the third threshold is 4, the calculating unit 350 may compare the 4 number of the nodes with the set value of the number of nodes.

The set value of the number of nodes is a value for classifying the stylus touch input and the proximity touch input. Here, in a case in which the number of periphery nodes exceeding the third threshold is greater than the set value of the number of nodes, the calculating unit 350 may determine that the effective data within the touch input group is generated by the proximity touch(hover) input (S545), and in a case in which the number of periphery nodes exceeding the third threshold is less than or equal to the set value of the number of nodes, the calculating unit 350 may determine that the effective data within the touch input group is generated by the stylus touch input(S550). As an example, in a case in which the set value of the number of nodes is set to 3, since the set value of the number of nodes of 3 is less than the number of periphery nodes of 4, the calculating unit 350 may determine that the second touch input group is generated by the proximity touch input.

According to the exemplary embodiment, the calculating unit 350 may obtain a plurality of pieces of sensing data corresponding to the changes in capacitance of the plurality of node capacitors C11 to Cmn in a single frame, once, and may change at least one of the first to third thresholds and the set value of the number of nodes in a current frame according to a type of touch determined in a previous frame. The calculating unit 350 may periodically generate the pieces of effective data according to the pieces of sensing data sequentially input thereto and determine the touch input. Here, according to the exemplary embodiment, since the touch input made by the user may have a constant directivity, the calculating unit 350 may change at least one of the first to the third thresholds and the set value of the number of nodes in the current frame so as to maintain the type of touch input made in the previous frame.

For example, in a case in which a general touch input is made in the previous frame, the calculating unit 350 may set the first threshold in the current frame to be lower than that of the previous frame. In addition, in a case in which the proximity touch input is made in the previous frame, the calculating unit 350 may set the first threshold in the current frame to be higher than that of the previous frame or set the set value of the number of nodes in the current frame to be lower than that of the previous frame.

As set forth above, according to exemplary embodiments of the present disclosure, a general touch input, a hovering touch input, and a stylus touch input may be effectively classified.

While exemplary embodiments have been shown and described above, it will be apparent to those skilled in the art that modifications and variations could be made without departing from the spirit and scope of the present disclosure as defined by the appended claims.

What is claimed is:

1. A touchscreen apparatus comprising:
a panel unit including a plurality of driving electrodes and a plurality of sensing electrodes intersecting with the plurality of driving electrodes;
a sensing circuit unit detecting levels of capacitance from the plurality of sensing electrodes; and
a calculating unit generating a plurality of pieces of effective data corresponding to nodes of the plurality of driving electrodes and the plurality of sensing electrodes from the levels of capacitance,
wherein the calculating unit sets a portion of the plurality of pieces of effective data as at least one touch input group and determines a type of touch input according to a level of a piece of effective data having the maximum value within the at least one touch input group and the number of pieces of effective data having a predetermined level or more among peripheral pieces of effective data adjacent to the piece of effective data having the maximum value.

2. The touchscreen apparatus of claim 1, wherein the calculating unit generates the pieces of effective data by subtracting a predetermined offset value from sensing data generated by performing analog-digital conversion on the levels of capacitance.

3. The touchscreen apparatus of claim 1, wherein the at least one touch input group corresponds to a square region surrounding pieces of effective data having a predetermined reference value or more among the plurality of pieces of effective data, at a shortest distance.

4. The touchscreen apparatus of claim 1, wherein the at least one touch input group corresponds to a touch input candidate region determined by a touch separation algorithm.

5. The touchscreen apparatus of claim 1, wherein the calculating unit compares the piece of effective data having the maximum value with a predetermined first threshold.

6. The touchscreen apparatus of claim 5, wherein the calculating unit determines that the touch input group corresponding to the piece of effective data having the maximum value is generated by a general touch input, in a case in which the piece of effective data having the maximum value is greater than the first threshold.

7. The touchscreen apparatus of claim 6, wherein the calculating unit compares the piece of effective data having the maximum value with a predetermined second threshold, in a case in which the piece of effective data having the maximum value is equal to or less than the first threshold.

8. The touchscreen apparatus of claim 7, wherein the calculating unit determines that the touch input group corresponding to the piece of effective data having the maximum value is generated by noise, in a case in which the piece of effective data having the maximum value is equal to or less than the second threshold.

9. The touchscreen apparatus of claim 7, wherein the calculating unit compares the number of pieces of effective data exceeding a predetermined third threshold among the peripheral pieces of effective data adjacent to the piece of effective data having the maximum value with a set value of the number of nodes, in a case in which the piece of effective data having the maximum value is greater than the second threshold.

10. The touchscreen apparatus of claim 9, wherein the calculating unit determines that the touch input group corresponding to the piece of effective data having the maximum value is generated by a proximity touch input, in a case in which the amount of the pieces of effective data exceeding the third threshold among the peripheral pieces of effective data adjacent to the piece of effective data having the maximum value is greater than the set value of the number of nodes.

11. The touchscreen apparatus of claim 9, wherein the calculating unit determines that the touch input group corresponding to the piece of effective data having the maximum value is generated by a stylus touch input, in a case in which the amount of the pieces of effective data exceeding the third threshold among the peripheral pieces of effective data adjacent to the piece of effective data having the maximum value is equal to or less than the set value of the number of nodes.

12. The touchscreen apparatus of claim 1, wherein the type of touch input includes a general touch input, a proximity touch input, and a stylus touch input.

13. The touchscreen apparatus of claim 9, wherein the third threshold is determined from an average value of the pieces of effective data by a stylus touch input and a proximity touch input.

14. The touchscreen apparatus of claim 9, wherein the third threshold is determined by multiplying the piece of effective data having the maximum value by a predetermined threshold ratio.

15. A touchscreen apparatus comprising:
a panel unit including a plurality of driving electrodes and a plurality of sensing electrodes intersecting with the plurality of driving electrodes;
a sensing circuit unit detecting levels of capacitance from the plurality of sensing electrodes; and
a calculating unit generating a plurality of pieces of effective data corresponding to nodes of the plurality of driving electrodes and the plurality of sensing electrodes from the levels of capacitance,
wherein the calculating unit sets a portion of the plurality of pieces of effective data as at least one touch input group, compares a level of a piece of effective data within the at least one touch input group with a plurality of thresholds to determine a type of touch input according to a result of the comparision, and changes a level of the plurality of thresholds in a current frame so as to maintain the type of touch input in a previous frame.

16. A touch sensing method, comprising:
generating a plurality of pieces of effective data corresponding to nodes of a plurality of driving electrodes and a plurality of sensing electrodes;
setting a portion of the plurality of pieces of effective data as at least one touch input group; and
determining a type of touch input by comparing a piece of effective data having the maximum value within the at least one touch input group with predetermined first and second thresholds and comparing the number of pieces of effective data having a predetermined third threshold or more among peripheral pieces of effective data adjacent to the piece of effective data having the maximum value with a predetermined set value of the number of nodes.

17. The touch sensing method of claim 16, wherein the first to third thresholds and the set value of the number of nodes in a current frame are changed so as to maintain the type of touch input in a previous frame.

18. The touch sensing method of claim 16, wherein in the generating of the plurality of pieces of effective data, the pieces of effective data are generated by detecting levels of capacitance from a panel unit to which the touch input is applied, performing an analog-digital conversion on the levels of capacitance to generate sensing data, and subtracting a predetermined offset value from the sensing data.

19. The touch sensing method of claim 16, wherein the peripheral pieces of effective data are included in the touch input group.

20. The touch sensing method of claim 16, wherein in the determining of the type of touch input, in a case in which the piece of effective data having the maximum value is greater than the first threshold, it is determined that the touch input group corresponding to the piece of effective data having the maximum value is generated by a general touch input.

21. The touch sensing method of claim 16, wherein in the determining of the type of touch input, in a case in which the piece of effective data having the maximum value is equal to or less than the first threshold, the piece of effective data having the maximum value is compared with the second threshold.

22. The touch sensing method of claim 21, wherein in the determining of the type of touch input, in a case in which the piece of effective data having the maximum value is equal to or less than the second threshold, it is determined that the touch input group corresponding to the piece of effective data having the maximum value is generated by noise.

23. The touch sensing method of claim 21, wherein in the determining of the type of touch input, in a case in which the piece of effective data having the maximum value is greater than the second threshold, the number of pieces of effective data exceeding the third threshold among peripheral pieces of effective data adjacent to the piece of effective data having the maximum value is compared with the set value of the number of nodes.

24. The touch sensing method of claim 23, wherein in the determining of the type of touch input, in a case in which the number of the pieces of effective data exceeding the third threshold among peripheral pieces of effective data adjacent to the piece of effective data having the maximum value is greater than the set value of the number of nodes, it is determined that the touch input group corresponding to the piece of effective data having the maximum value is generated by a proximity touch input.

25. The touch sensing method of claim 23, wherein in the determining of the type of touch input, in a case in which the number of the pieces of effective data exceeding the third threshold among peripheral pieces of effective data adjacent to the piece of effective data having the maximum value is equal to or less than the set value of the number of nodes, it is determined that the touch input group corresponding to the piece of effective data having the maximum value is generated by a stylus touch input.

26. The touch sensing method of claim 16, wherein the type of touch input includes a general touch input, a proximity touch input, and a stylus touch input.

27. The touch sensing method of claim 16, wherein the third threshold is determined from an average value of the pieces of effective data by a stylus touch input and a proximity touch input.

28. The touch sensing method of claim 16, wherein the third threshold is determined by multiplying the piece of effective data having the maximum value by a predetermined threshold ratio.
